(19) United States
(12) Patent Application Publication
(10) Pub. No.: US 2004/0262994 A1
(43) Pub. Date: Dec. 30, 2004

(54) Method and device for reducing the brake load at at least one wheel brake

(76) Inventors: Dietmar Baumann, Hemmingen (DE); Dirk Hofmann, Ludwigsburg (DE); Herbert Vollert, Vaihingen/Enz (DE); Willi Nagel, Remseck/Hochdorf (DE); Rolf Maier-Landgrebe, Kernen (DE); Andreas Henke, Diemelstadt (DE); Bertram Foitzik, Ludwigsburg (DE)

Correspondence Address: KENYON & KENYON, ONE BROADWAY, NEW YORK, NY, 10004, US

(21) Appl. No.: 10/821,738

(22) Filed: Apr. 9, 2004

(30) Foreign Application Priority Data
Apr. 9, 2003 (DE) 103 16 090.6

(51) Int. Cl. B60T 13/66

(52) U.S. Cl. 303/155; 303/113.5; 303/20

(57) ABSTRACT

A method and a device for monitoring and controlling the braking system of a vehicle. In this context, for the monitoring, at least one braking variable representing the retarding force of at least one wheel brake is recorded, and is compared to a predefined threshold value. As a function of the comparison and of the driving situation of the vehicle and/or the operating state, at least one vehicle component located in the vehicle carries out at least one suitable measure during a braking procedure which modifies the slowdown at at least one wheel brake. In this context, it is observed that the overall slowdown of the vehicle should be held constant during the modification of the slowdown at the at least one wheel brake, or in any event, should be changed insignificantly.

### RELATED APPLICATION INFORMATION

This application claims the benefit of and priority to German Patent Application No. 103 16 090.9, which was filed in Germany on Apr. 9, 2003, and the contents of which is incorporated by reference.

### FIELD OF THE INVENTION

The present invention relates to a method and a device for monitoring and controlling the braking system of a vehicle.

### BACKGROUND INFORMATION

According to certain standards, the brake systems of current vehicles may be furnished with friction brakes (e.g. disk brakes or drum brakes) for producing slowdown of the vehicle. In these brakes, a frictional force is generated, by pressing a friction lining against a rotor, which, in turn, gives rise to a braking torque. The slowdown achieved in this context is predominantly a function of the conditions of the frictional contact between friction lining and the rotor. In this context, the so-called friction value μ corresponds to the ratio of the friction force F_{fr} to the applied normal force F_{N}. This friction value μ is subject to strong fluctuations and is temperature-dependent. Thus, the friction value drops to a minimum value at high temperatures of the frictional partners.

If the friction value drops below a setpoint value for keeping up the slowdown, this is called brake fading. The result is that, at the brake, a higher normal force has to be generated, which, on its part, in turn, generates a sufficiently high frictional force or a sufficiently high frictional torque for the desired vehicle slowdown. An increase in temperature at the two frictional partners being in frictional contact, and consequently a drop in frictional value μ may, for example, come about by frequent braking within a short period (strong braking) or by long downhill travel in which the brake is constantly activated. However, if there are no unusual braking operations, such as during daily inner city traffic, brake fading occurs only rarely. In spite of this, it is necessary to design the brake for low frictional values or high normal forces which thereby become necessary. This means a high mechanical effort which, among other things, goes along with high weight and high costs for the brake, and also the activating unit.

One possibility of avoiding brake fading is to modify the braking force distribution during a braking procedure between the wheels of the front axle and the rear axle. In a conventional brake force distribution, a fixed ratio of the brake force between the front axle and the rear axle is implemented in that, front and back, the same hydraulic pressure is made to act on differently sized brakes. In this context, corresponding to legal regulations, the brake force distribution is chosen so that, if possible, the rear axle does not lock before the front axle. This different braking force distribution may, for example, be achieved by the use of a braking pressure reducer, different frictional radii at the brakes of the front and rear axles, as well as an electronic braking force distribution (EBV). The backdrop of the braking force control at the axles is that, in the case where the rear axle is braked too strongly, the vehicle may become unstable during braking on a curve, i.e. it may tend to skid. German Patent Publication No. 4 128 087 refers to a brake pressure control system for a vehicle in which under-braking of a rear axle during curve braking is prevented as a result of the circular geometry. In this context, the braking pressure at the front axle is specified by the driver and the braking pressure at the rear axle is adjusted. In this context, the regulation is designed in such a way that the tire slip angle of the rear axle is adapted to the tire slip angle of the front axle.

An additional braking pressure distribution, which ensures as great as may be possible a braking of the vehicle having optimal force-locking utilization, is to undertake the braking pressure distribution to the vehicle axes according to different criteria. In this context, for example, one may at first proceed up to the control level of maximum braking force at one axle, and after the optimal braking force distribution, using the same force-locking stress, at all axles. Subsequently, the braking effect at the axles is increased using the still lower braking pressure, in order to achieve the slowdown desired by the driver.

One may also distribute the braking pressures or the braking forces corresponding to the same force-locking stress for differently dynamically loaded wheels. In European Patent Application No. 0 173 954, the braking pressures for the brakes of the two axles are ascertained by way of a reference mass for the vehicle and the setpoint slowdown predefined by the driver in a filed, vehicle-specific characteristics map. These ascertained braking pressures are input at the brakes and are appropriately modified when there is deviation of the vehicle slowdown value, achieved in this context, from the setpoint slowdown value, until the actual vehicle slowdown value corresponds to the setpoint slowdown value. In this context, because of the new braking pressures, a new reference mass of the vehicle is ascertained at the axles, and is stored as the new reference mass.

German Patent Publication No. 3 313 078 refers to a new braking pressure control device is proposed, which utilizes the nonuniform stress of the wheel brakes of a vehicle. A different wear of the respective brake linings is connected with the nonuniform stress, which leads to different residual thicknesses at the wheel brakes. A uniform wear of the brake lining among the wheels is achieved using the braking pressure control device that is referred to in German Patent Publication No. 3 313 078, the partial holding back of the braking pressure afforded by the braking pressure control device, corresponding to the wear-dependent braking pressure supply, not, in fact, making the overall behavior of the brake system less uniform, but rather correcting it in the direction of harmonization, by countering nonuniform braking effects and brake lining wear influences.

### SUMMARY OF THE INVENTION

The exemplary embodiment and/or exemplary method of the present invention relates to a method and a device for monitoring and controlling the braking system of a vehicle. In particular, as a function of a comparison of a recorded braking variable to at least one predefined threshold value, the travel situation and the operating state of a vehicle component located in the vehicle during a braking procedure, at least one suitable measure is carried out or performed which modifies the slowdown at at least one wheel brake, the overall response delay of the vehicle being held constant or changed insignificantly.

The exemplary embodiment and/or exemplary method of the present invention relates to a method and a device for monitoring and controlling the braking system of a vehicle. In this context, for the monitoring, at least one braking variable representing the retarding force of at least one wheel brake is recorded, and is compared to a predefined threshold value. As a function of the comparison and of the driving situation of the vehicle and/or the operating state, at least one vehicle component located in the vehicle performs or carries out at least one suitable measure during a braking procedure which modifies the slowdown at at least one wheel brake. In this context, it should particularly be observed that the overall slowdown of the vehicle should be held constant during the modification of the slowdown at the at least one wheel brake, or in any event, should be changed insignificantly.

Advantageously, as a suitable measure, a redistribution of the retarding force from at least one wheel brake to at least one other wheel brake of the vehicle is provided, and/or an unloading of the wheel brake by utilization of components of the vehicle absorbing (taking up) energy, and/or a modification of the engine control. By the use of these measures, brake fading, for example, may be successfully prevented or compensated for at the monitored wheel brakes of the vehicle. In a further exemplary embodiment of the present invention, in the case of the recorded braking variable, a variable is recorded that represents the load of the wheel brake during a braking activity. In this context, as the braking variable, a temperature variable representing the temperature at at least one of the friction partners of the wheel brake may be recorded, and/or a friction variable representing the frictional value between the friction partners of the wheel brake and/or a wear variable of the brake lining of the wheel brake, which represents the wear and/or a braking power of the wheel brake and/or a current slowdown of the wheel brake. In another exemplary embodiment of the present invention, beside the absolute value of the braking variable, the pattern over time of the braking variable and/or the change with time of the load of the wheel brake may also be recorded.

Since the modification of the slowdown of the vehicle may be a function of the instantaneous driving situation, in one additional specific embodiment it is provided, in view of the time behavior of the braking requirement, which may be controlled by the driver and also by a component present in the vehicle for brake control, such as an antilock brake system (ABS), an electronic stabilization program (ESP) or an adaptive cruise control (ACC), that the control and the loading of the components present in the vehicle be monitored with the aid of plausibility interrogations. However, besides the variation with time of the braking requirement it is also optionally conceivable that the variation with time of the steering requirement by the driver and/or a component present in the vehicle for steering control be recorded, and used as driving situation for the monitoring and modification of the brake control. In addition, besides components present in the vehicle, the presence of a trailer may also be queried, in order to obtain a correspondingly tuned modification of the brake control.

Since various vehicle components have an influence on the control of the wheel brakes and on the slowdown produced, it is provided that one should query the operating condition of at least the battery and/or of the wheel brakes and/or of the engine. In this context, for example, the loading state of the battery, the operating condition of the wheel brakes, in particular the instantaneous braking power at the wheel brakes and/or an instantaneous engine output of the engine may be recorded and may be taken into consideration in the modification of the slowdown at the corresponding wheel brakes.

Because of the redistribution of the retarding force from the wheel brakes of the non-driven axle to the wheel brakes of the driven axle, recovery (recuperation) of the braking energy may take place if appropriate energy-absorbing components are present at the wheel brakes of the driven wheels. The energy regained in this context may be supplied to the battery. Advantageously, this energy gain is mainly carried out when the battery is not maximally loaded, and consequently is in a partially loaded state. However, if the battery is fully loaded, then, in another exemplary embodiment of the present invention, the energy gained may be guided away by additionally connecting users such as the lighting system.

In general, using the exemplary embodiment and/or exemplary method of the present invention, a reduction in brake power of greatly stressed brakes may be reduced. By using the measures mentioned for the intelligent control and utilization of the brakes accommodated in the vehicle, the stress of each monitored wheel brake may be reduced, friction brakes having a lower weight and lower costs being able to be implemented. This may happen, for example, in that the operating unit of a friction brake is dimensioned smaller, and therefore lighter and more cost-effectively, without having to do without the required slowdown potential during a braking procedure. Furthermore, in the case of an electro-mechanically operated brake, lower requirements are created on the maximal electrical power requirements, whereby in response to the electrical drive, there comes about an enormous savings potential with respect to its costs. In addition, because of the redistribution of the retarding force to the various wheel brakes, a uniform wear at all wheel brakes may be implemented. Thereby, maintenance and replacement costs may be saved. By the utilization of all the measures mentioned, the wear of friction brakes may also be reduced.

Besides the possibilities mentioned so far of intelligent control of the wheel brakes, an additional suitable measure for redistribution of the braking force at the wheel brakes may be seen in that, in vehicles having rear drive and brake energy recovery, the braking force proportion of the rear wheels is increased to the extent that is meaningful for an optimal utilization of the braking energy, without impairing the stability of the vehicle. In particular, in the case of a vehicle having hybrid drive, the advantage, in this context, is that there is an additional savings in consumption. This is higher the more brake operations take place. Because of the greater braking forces at the rear wheels, more mechanical power is able to be converted into electrical power in the generating operation of the E-machine (which may be a synchronous, asynchronous or DC piece of equipment), and thereby regained.

In order to ensure the necessary vehicle stability, increasing braking power at the rear axle for the purpose of regaining energy makes sense only in braking procedures during straight-ahead driving. This may be ensured, for example, via interrogation of steering demands passed on to the wheels and/or on account of plausibility interrogations of the vehicle components. Since, however, a large part of braking activities occurs during straight-ahead driving, the braking energy recovery is able to be used over the greatest part of the vehicle operation. A brake-by-wire system, such as the electro-hydraulic brake (EHB) offers substantial advantages for braking energy recovery, because in it, hydraulic and generating brakes may be coordinated relatively simply. Since such a braking system ascertains the braking force distribution (BKV) using a microcomputer, the energy recovery is relatively easy to implement by modification of the existing BKV program.

### BRIEF DESCRIPTION OF THE DRAWINGS

FIG. 1 shows an overall view of the determination of an overload of at least one wheel brake.

FIG. 2 shows a flow chart to show the monitoring and the initiation of suitable measures for reducing the overload.

FIG. 3 shows a representation of the input for braking force distribution with the aim of braking energy recovery.

FIG. 4 shows an exemplary embodiment in which is shown schematically the control of the braking energy recovery.

FIG. 5 shows an example of how the adaptation of the braking torque can take place by the modified braking force distribution during braking on a curve.

### DETAILED DESCRIPTION

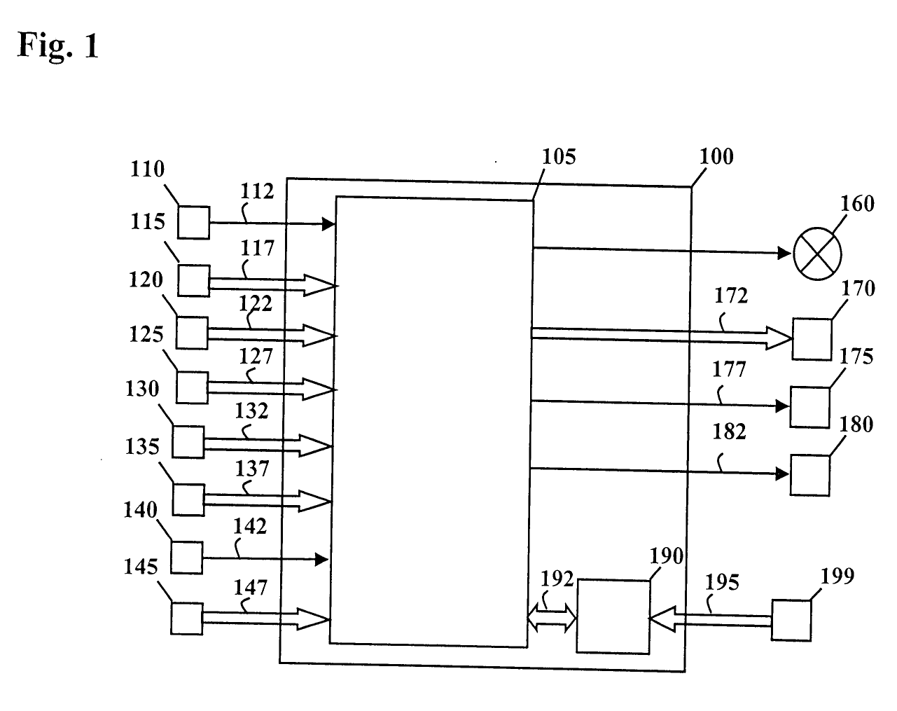

Using the exemplary embodiment and/or exemplary method of the present invention, the operating condition of at least one friction brake with respect to its friction value is monitored, and if a reduction of the friction value is determined, a corresponding countermeasure is initiated, in order to ensure the applicability or the braking capability of the monitored wheel brakes during a brake operation. The wheel brakes are able to be used at substantially greater efficiency because of the measures described below. In general, using a modified control of the wheel brakes, one may achieve a reduction in the wear of the brake linings. This happens, for instance, by distributing the wear uniformly to all the wheel brakes. However, a prerequisite for the application of the exemplary embodiment and/or exemplary method of the present invention is that central steering unit 105, as illustrated in FIG. 1, has at its disposal sufficient parameters of the braking system and the wheel brakes. Although the monitoring and the control of the braking system using the wheel brakes may also be permanently applied, in the following exemplary embodiment, the application is limited to there being present a braking command. However, this takes place without a restriction to the general applicability of the exemplary embodiment and/or exemplary method of the present invention. Thus, it is conceivable that one may initiate appropriate measures even before the braking command, if there is present a corresponding exceeding of a threshold value.

A braking command, as is generated, for example, by the driver and/or by an automatic braking system in the vehicle, may be generated, for instance, in block 110. This braking command may, for instance, be indicated using a flag F_{B} (112). This may, for example, happen in that a set flag F_{B}=1 corresponds to a braking command. Correspondingly, a non-set flag F_{B}=0 is a sign that there is no braking command. This braking command F_{B} (112) is used in central control and monitoring unit (105) to start a recording of the condition parameters and operating parameters of the braking system including the wheel brakes, and to initiate suitable measures for increasing the friction value between the friction partners of the wheel brake, if it is determined that there has been a reduction in the friction value and/or an increase in the temperature beyond a critical temperature.

Various parameters are read in to determine brake fading at a wheel brake, which characterize the operating state of the wheel brake, particularly the friction behavior of the wheel brake. For this purpose, block 115 of FIG. 1 represents a system of temperature sensors and/or friction value sensors at the wheel brakes. In this context, using the temperature sensors, both individual friction partners and both friction partners may be monitored with respect to temperature. Consequently, block 115 yields temperature values T_{B,i} (117) and/or friction values μᵢ (117) of the individual wheel brakes i. Besides the temperature and friction values of the individual wheel brakes, wear Vᵢ (122) of the brake linings may be drawn upon as a measure for the stress of the wheel brake. For this purpose, in block 120, a wear sensor and/or a wear model is interrogated, which passes on the instantaneous wear Vᵢ (122) at wheel brake i to central processing unit 105. For the selection of suitable measures for increasing the friction value at the wheel brakes, and for reducing the temperature at the wheel brakes, the actual operating state 127, or rather the brake controls 127 created because of the braking command, at the individual wheel brakes are read in from the control of the braking system in block 125 into central processing unit 125. Because of reading in the operating data 127 of braking system 125, an instantaneous slowdown of the wheel brakes may be ascertained. Braking systems are also made up of wheel brakes.

Besides the operation of the braking system and the wheel brakes, a slowdown of the vehicle may also be achieved by a reduction of the engine output. In order to estimate the potential of a modified engine control, the operating state of engine 130 or its control is also read into central processing unit 105. However, certain measures described below can only be carried out in the case of very special driving situations. To obtain a possible decision criterion for deciding in which driving situation the vehicle exists, one may use steering command 137 connected to steering system 135 by the driver and/or an additional component present in the vehicle for steering control. Besides the steering commands, the braking commands, such as by an ABS, ASR, ESP or an ACC, may also be drawn upon for the detection of a certain travel situation.

If components are accommodated within the vehicle which may be used for taking up energy during current vehicle operation, such as a starter generator, engine brake, wheel brake, etc, the operating state 145 of these components 147 may also be taken up as a decision parameter for the selection of the measures to be initiated.

Information on the loading state 142 of battery 140 may be used for several reasons in central processing unit 105. Thus, in connection with energy-accepting components, the loading state of battery 140 may be increased to a maximum. If the wheel brakes in the vehicle are, in addition, also directly or indirectly electrically controllable (for instance, by an electro-hydraulic or an electric motor brake), loading state 142 of battery 140 may have information to give on the maximum generatable braking effect at the wheel brakes.

In central processing unit 105, the parameters taken up and/or the operating states of the vehicle components or systems present in the vehicle and taken into consideration are compared to threshold values, in order to determine a decrease in the friction value at the individual wheel brakes and/or an increase in the temperature at the friction partners of the wheel brakes. The threshold values applicable to the individual wheel brakes of the temperature SW_{T,i}, of the friction value SW_{μ,i} and of the wear SW_{V,i} are read in from nonvolatile memory 190. In this nonvolatile memory 190, the corresponding threshold values may be stored during the assembly of the vehicle and/or an exchange of the wheel brakes and/or the brake linings, for instance, during a stay at a repair garage 199, or during routine servicing 199. In central processing unit 105, plausibility queries may be made in the light of the parameters read in and the operating states of the vehicle components which may have an effect on the wheel brakes. If, during this query, it is determined that at least one wheel brake has a reduced friction value, and consequently a reduced braking activity, according to the scheme described below, various measures are weighed against one another that might lead to an improvement of the braking capability at the affected wheel brake or even of the entire vehicle. In addition, an appropriate device 160 allows for informing the driver both optically and acoustically concerning the reduced braking capability of the affected wheel brake. That allows for the driver actively to adapt his driving behavior to the circumstances.

In a vehicle, if in addition to the braking system further components are used to implement the slowdown of the vehicle, the brakes may thereby be unloaded thermally, and a strong decrease in the friction value at the wheel brakes may be prevented. Depending on the travel situation and the operating state of the individual components present in the vehicle, individual measures may thus slow down the vehicle in addition or alternatively to the friction brakes.

In this context, in the present exemplary embodiment, the measures provided involve, for example, the use of energy-accepting systems 175. In this context, one may undertake converting kinetic energy of the vehicle into electrical energy, for instance, using a starter generator that is operated to brake the vehicle as a generator. This procedure is described by the concept of recovery. In case battery 140 or the energy storage is already full, additional electrical users may also be connected additionally, such as lighting or heating, in order to conduct away the regained energy.

Furthermore, by a modification of engine control 180, the engine may be throttled, and by the reduction of the drive achieved thereby, a slowdown of the vehicle may be achieved. Thus, throttling the engine acts as an engine brake.

By the plausibility queries carried out in central processing unit 105, a “misuse”, such as the simultaneous operation of the brake pedal and the accelerator may be questioned. A reduction in the drive command to the engine due to the accelerator along with a simultaneous braking command may, in this context, be made stepwise, or it may be completely switched off. A reduction in engine power is also appropriate if multiple rapid accelerations and subsequent braking take place within a certain time. Thereby overheating of the brake may be avoided, in that the engine power is electronically limited for a limited time, in case the brake moves in the direction of a thermally critical state.

Another measure for unloading individual wheel brakes is represented by the redistribution of the total braking force to only three or two wheel brakes. In this context,from time to time, one or two wheel brakes may be completely unloaded, so that in these brakes overheating can be avoided. To be sure, in this phase, the speed of heating up the operated wheel brakes is greater than during uniform operation of all the wheel brakes, but the maximum temperature of each individual wheel brake may be reduced by the alternating operation of the wheel brakes. The reason is that, in the case of the brakes that are not used, from time to time a larger surface is available for giving off thermal energy (linings lifted off). By using an electronic stability program (ESP), driving stability may be maintained even during alternating operation of the wheel brakes. All in all, using this strategy, on the one hand, fading of the wheel brakes may be avoided, and on the other hand, because of the low temperatures, the overall wear of the brake linings may be reduced. In addition, using this strategy, brake lining wear of the braking system may be equally distributed, uniformly to all the linings. The result is that the intervals of changing them may be extended, and the maintenance costs are reduced.

However, besides alternating activation of the wheel brakes, in general, redistribution of braking force from the brakes of the front axle to the brakes of the rear axle may take place. In conventional braking systems, the distribution of the braking power between the front and the rear axles leads to the brakes at the rear axle affording substantially less braking performance than the brakes at the front axle. This may be understood in that the brakes at the rear axle are equipped to have smaller brake disks and smaller brake linings than the brakes at the front axle. Because of the smaller brake disks, the brakes at the rear axle have a lower heat capacity. If, as in current braking systems and, above all, in brake-by-wire systems, the braking force distribution between front and rear axles were adjusted dynamically to the current driving situation, this would result in a greater temperature increase, on average, at the brakes of the rear axle. If one then increases the heat capacity of the wheel brakes at the rear axle by larger brake disks, the brakes at the front axle may be unloaded, and the overall braking system may thus be operated at a lower temperature level.

In order to carry out the modified brake control described, central processing unit 105 passes on appropriate brake control signals 187 to braking system control 185. In braking system control 185 then, in conjunction with the braking commands by the driver or by automatic braking systems (such as ESP, ABS, ACC, ASR, etc), appropriate brake control signals may be ascertained and the braking system may be controlled.

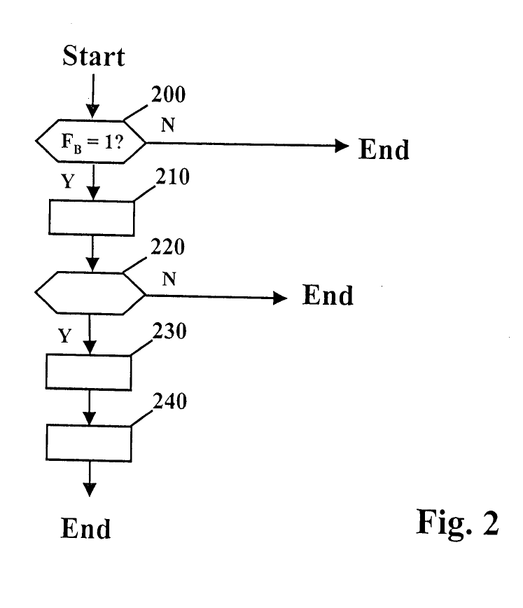

In a flow chart, FIG. 2 shows the comparison of the taken up temperature, friction value and/or wear parameters to threshold values SW_{T,i}, SW_{μ,i}, SW_{V,i} that are critical to the wheel brakes. In order to reduce brake fading, operating states 127, 132, 137, 142, 147 of the vehicle components under consideration, braking system 125, engine or engine control 130, steering 135, battery 140 and energy-absorbing systems 145 continue to be read in, in order to interrogate to what extent the components may be controlled.

After the start of the algorithm in FIG. 2, in step 200, braking command F_{B} (112), which is brought about by the driver and/or by a system 110 controlling the braking system, is interrogated. If a set flag F_{B} (i.e. F_{B}=1) is determined, a braking command is determined and the algorithm is further processed using step 210. However, if there is no braking command, i.e. in step 200 an unset flag F_{B} (i.e. F_{B}=0) is determined, the algorithm is ended. In step 210, temperatures T_{B,i} (117), friction values μᵢ (117) and or wear Vᵢ (122) are recorded using appropriate sensors and/or models (115 or 120, respectively) at wheel brakes i. The value of wear Vᵢ (122), in this context, may be recorded by a sensor (120), but also by a suitable wear model 120. In subsequent step 220, parameters 117 or 122, respectively, thus recorded, are compared to the corresponding threshold values SW_{T,i} and/or SW_{μ,i} and/or SW_{V,i} read in from nonvolatile memory 190. In this context, the threshold values each represent a still maximally permissible value, at which danger of brake fading is not yet to be observed at the wheel brakes. In response to modification of the braking system, such as by exchange of wheel brakes or brake linings, it may be necessary that new threshold values apply. It is therefore provided that the data in memory 190 be updated by an external access 199.

In the following, as a simplified representation, the algorithm in FIG. 2 is shown in the light of the monitoring of temperature T_{,i} at a wheel brake i. However, the algorithm may also be used correspondingly for the monitoring of friction value μᵢ (117) and/or wear Vᵢ (122). In addition, when it comes to wear Vᵢ (122), different wear marks may also be monitored, in each case different threshold values SW_{V,i} being stored in memory 190.

In step 220, the recorded temperature T_{,i} is compared to the read-in threshold value SW_{T,i}. In this context, threshold value SW_{T,i} represents a critical temperature of the friction partner(s) observed. If this critical temperature SW_{T,i} is not exceeded, the algorithm is ended. However, if the instantaneous temperature T_{B,i} lies above this critical temperature SW_{T,i}, the temperature difference

Δt=T_{,i}−SW_{T,i}

from threshold value SW_{B,I} is ascertained in step 230. In subsequent step 240, it is checked, in the light of the detected exceeding of critical boundary temperature SW_{T,i}, which countermeasure might be applied for reducing brake temperature T_{,i} and thus for increasing friction value μᵢ. A decision as to which of the measures mentioned are initiated may, for instance, be made as a function of temperature difference Δt and/or of a previously specified ranking sequence.

Besides the avoidance of fading, it is also useful and meaningful, based on the recording of the state of the overall braking system, to inform the driver on the state of the braking system, and to give an appropriate warning in case of very stressed brakes. This can be done by optical and/or acoustical indications, but particularly also by a “worsening” of the feel of the accelerator (haptic pedal behavior). In order to achieve a certain slowdown, in the case of highly stressed brakes, a greater pedal force is required than in the standard operating case.

In the measures initiated, additionally the state of all wheel brakes may be taken into consideration. Thus it is recognized whether only one wheel brake or several wheel brakes exceed the critical temperature or almost reach it. If the possibility of energy recovery is available, the loading state of the battery may be interrogated, for example. If there is still further loading capacity, the energy-absorbing systems of the vehicle can convert kinetic energy into electrical energy and consequently support the slowdown independently of the friction brakes. If possible, in the case of a fully loaded battery, the additional connecting of users is conceivable. However, in order not to endanger driving stability unnecessarily, the energy recovery is to be used predominantly during braking procedures during straight-ahead driving. Corresponding information as to whether the vehicle is currently traveling along a curve or straight ahead, is obtained from steering system 135, for example. On the other hand, an unloading from time to time of individual wheel brakes should mainly be carried out if individual wheel brakes are being used excessively compared to the remaining wheel brakes. A reduction of engine power and the use of the motor as an engine brake is conceivable, however, in most cases without a restriction in driving stability.

A general modification of the control of the braking system, regardless whether for the improvement of the brake energy recovery or for reducing brake fading, depends on the situation. For instance, braking force distribution may only be conditionally modified during braking while traveling on a curve. For recognition of the situation, the driving dynamics sensor signals from the electronic stability program (ESP), which is at this time already standard equipment in many vehicles, are very helpful. They permit a purposeful modification of braking force distribution with respect to the detected travel situation.

As was mentioned before, the energy recovery represents another exemplary embodiment of the present invention. In this context, it is necessary for the vehicles to be equipped with system components that allows for the recovery of energy, and consequently the absorption and conversion of the kinetic energy of the vehicle motion into electrical energy. On account of this conversion, the vehicle is slowed down additionally and/or alternatively to friction brakes. For example, in a vehicle having(electro-)hybrid drive, the internal combustion engine is combined with at least one electric motor. Consequently, the electric motor can be driven by the generator during braking procedures. Furthermore, the absorbed mechanical (braking) energy can be converted into electric current by the electric motor. This electric current is then able to load the driving battery and/or feed the vehicle's electrical system (braking energy recovery). A substantial advantage of this method is that fuel usage may thereby be substantially reduced.

Since only the braking energy of the driving wheels can be recovered, in rear axle driven vehicles only the braking energy of the rear wheels is usable. The proportion of the braking power at the rear axle is determined, in this context, by a braking power distribution (BKV). In this context, the braking power distribution is decisive for the stability of a vehicle during braking. In order to avoid the skidding of a vehicle, the BKV must, as a rule, ensure that the rear wheels are not over-braked by the front wheels. Normally, one would shoot for a BKV at which force (non-positive) locking utilization is the same at the front and rear wheels, i.e. the ratio of retarding force to wheel load is the same at both axles. The usable braking energy is also the higher, the greater the wheel load of the rear wheels. Unfortunately, in the case of vehicles having standard drive (engine in front, drive in the rear) this is relatively low. This is caused, on the one hand, by the relatively heavy engine resting with substantially greater load on the front axle than on the rear axle. On the other hand, the rear axle is unloaded more and more during increasing slowdown, as a result of the (forward) pitching (nodding) movement of the vehicle. The result is that, in response to an ideal force distribution, depending on the slowdown, far less than half of the entire braking energy is able to be recovered. In order to convert as great a proportion of the braking energy into electrical energy, in the case of a modified BKV, the braking force proportion of the rear axle is increased above the value for the ideal BKV, if the driving situation permits it. Because of the higher braking force proportion of the rear axle, more braking energy therefore becomes usable, and the fuel usage of the vehicle is diminished correspondingly. In this context, it should be observed that the increase of the braking force proportion of the rear axle is legally permitted only in vehicles having an antilock system, such as an antilock brake system (ABS). One may also assume that vehicles that are equipped with the exemplary embodiment and/or exemplary method of the present invention, being greater-value vehicles, in addition also have an ESP.

Vehicles having standard drive have the engine in front and the driving wheels in the rear. These vehicles have an unfavorable static wheel load distribution for braking energy recovery (for example, 60% in front and 40% in the rear). The dynamic wheel load distribution becomes even worse with increasing slowdown, i.e. less than half the braking energy is usable by recovery.

A brake-by-wire system, as may be implemented, for example, using the electrohydraulic brake (EHB), offers considerable advantages for braking energy recovery, since hydraulic and generator-based braking are easily coordinated. A microprocessor normally takes over the ascertainment of BKV in such systems, and with its aid, the exemplary embodiment and/or exemplary method of the present invention is relatively easily implemented by a modification of the existing BKV program.

A braking torque distribution that is suitable for braking energy recovery may be achieved using the following description of another exemplary embodiment of the present invention.

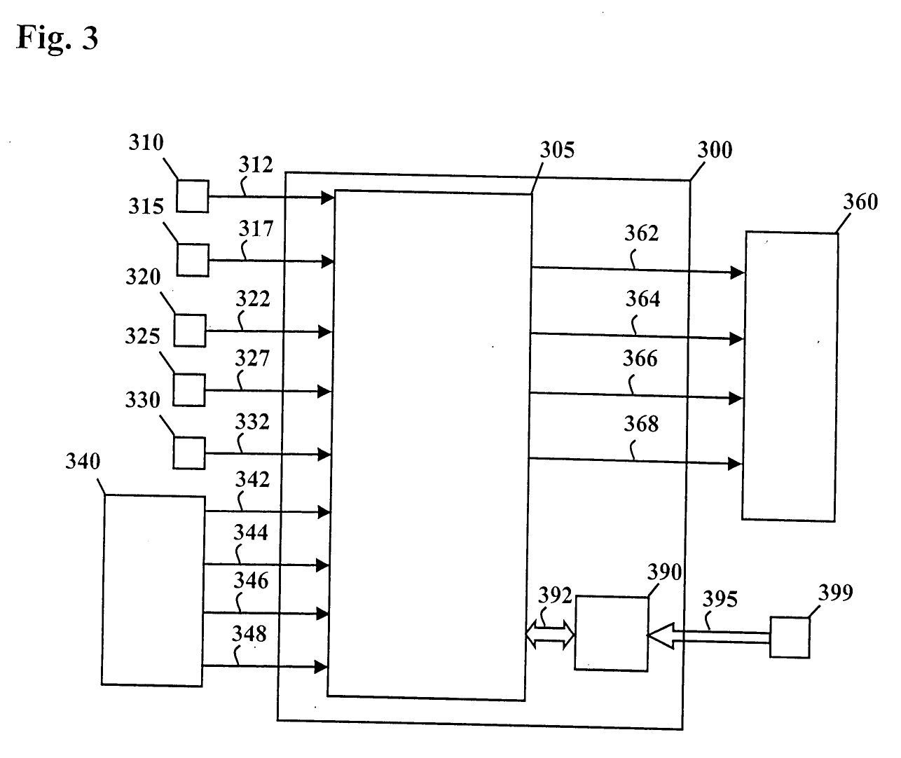

FIG. 3 represents an extension for the concrete case of energy recovery of the exemplary embodiment described in FIG. 1. In this context, block 305 corresponds to central processing unit block 105, memory 390 corresponds to memory 190 shown in FIG. 1, in which applicable variables may be stored. Because of a change in the braking system, it may be meaningful to modify these variables. For this reason, the possibility of a modification is provided by an external access 399.

Using central processing unit 305, modification of braking force distribution for energy recovery is carried out in energy absorbing components of the vehicle. In this context, it may be provided that the braking force distribution supplies setpoint braking torques to the wheel brakes independently of the exemplary embodiments of the present invention, or is integrated into the exemplary embodiment and/or exemplary method of the present invention. In the first case, the setpoint braking torques M_{HL} (342), M_{HR} (344), M_{VL} (346, M_{VR} (348) calculated from braking force distribution 340 located in the vehicle are read into central processing unit 305. Subscript H here stands for a braking torque at the rear wheel axle and V stands for a braking torque at the front wheel axle. Also, subscript L denotes a wheel on the left side of the vehicle and subscript R denotes a wheel on the right side of the vehicle. The modified braking torques (362 through 368) are passed on to brake control 360 after the determination of the presence of a suitable driving situation by central processing unit 305.

For the modification of the braking torques at the various wheels, various variables (312, 317, 322, 327, 332) are read into central processing unit 305, which are generated in standard fashion in the vehicle. In this context, for example, steering angle L_{W} (312) is involved, which is made available by steering control 310. This steering control 310 is able to generate the steering angle based on a steering command applied by the driver and/or by an automatic steering system. From yaw rate sensor 315, yaw rate v_{gi} (317) is able to be recorded. Furthermore, using an appropriate wheel sensor 320, the transverse acceleration a_{y} (322) of the vehicle may be ascertained. In standard fashion, vehicle speed v_{vehicle} (327) is generated in various systems 325 of the vehicle, for instance, based on variables recorded by wheel rotational speed sensors. The usable wheel braking power Pₘₐₓ (332) is determined by the components and the operating state of the vehicle. Additional important influential variables for determining the usable wheel braking performance are, in this context, the performance capability and the efficiency of the E machines, the transmission efficiency and the maximum permissible battery current, as well as the operability of the wheel brakes. An appropriate component 330, for instance, a power train control, takes into account these influence variables and makes available the usable wheel braking performance Pₘₐₓ (332)

Using these recorded parameters 312, 317, 322, 327, 332, the maximum usable rear axle braking torque is given as:

Mₘₐₓ=Pₘₐₓ/v_{vehicle}

At standstill of the vehicle, recovery is not or may not be possible, and consequently Pₘₐₓ becomes 0 and Mₘₐₓ becomes 0.

Taking into consideration a base braking torque M_{base}, which is used, for example, for applying the brake linings against the brake disk during braking, and consequently for saving time in response to rapid braking commands, one obtains as desired braking torque, for instance, for the rear left wheel

M*_{HL}=Mₘₐₓ/2+M_{base}

and correspondingly for the rear right wheel

M*_{HR}=M*_{HL}

With increasing braking torque, in particular at the rear axle of the wheel of the vehicle, the risk arises of bringing on an overbraking of the wheel. The ABS regulation then setting in has to reduce more or less strongly the braking torque, depending on the friction value between roadway and tire. Since a large braking torque reduction takes more time than a small one, high braking torques at the rear wheels should be avoided if possible. Therefore, raising the rear axle breaking force proportion is limited by the applicable force-locking stress K_μₘₐₓ to

M_{HL}**=min(M_{HL}*,K_μₘₐₓ·F_{N,HL}·K_{—}r_{Rad}) and

M_{HR}**=min(M_{HR}*,K_μₘₐₓ·F_{N,HR}·K_{—}r_{Rad})

In this context, F_{N,HL} and F_{N,HR} are the dynamic wheel loads rear left and rear right, and K_r_{wheel} is the dynamic wheel radius.

At the front axle, for safety reasons, a minimum braking torque (M_{VL} and M_{VR}) is called for. From that, the braking torques at the rear axle turn out to be:

$$\begin{matrix}{M}_{HL}^{** *} = min ( {M}_{HL}^{**} , {M}_{HL} + {K\_V}_{Mind} \cdot \frac{{M}_{VL} + {M}_{VR}}{2} \\ {M}_{HR}^{** *} = min ( {M}_{HR}^{**} , {M}_{HR} + {K\_V}_{Mind} \cdot \frac{{M}_{VL} + {M}_{VR}}{2}\end{matrix}$$

where K_V_{Mind} (where “Mind” corresponds to a minimum) may assume a value between 0 and 1. A value where K_V_{Mind}=0 represents a situation in which no increase of the braking force proportion is carried out at the rear axle. The braking force proportion of the front axle thus remains unchanged. As opposed to that, a value of K_V_{Mind}=1 means that there is no braking at the front axle.

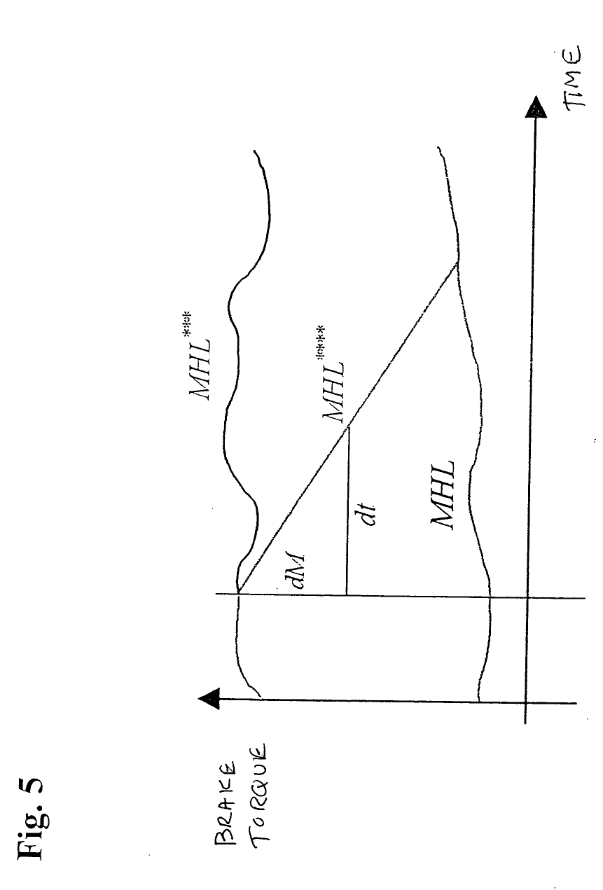

During braking on curves, the measures described effect an increase in the rear axle braking force proportion, but have an unfavorable effect on vehicle handling. Since the yaw response of the vehicle depends on BKV, a variation with time of the braking force distribution would lead to the vehicle reacting differently, and therefore not in an easily calculable fashion for the driver, during braking on a curve. For this reason, the desired braking torques M_{HL}**** and M_{HR}****, starting from M_{HL}*** and M_{HR}***, are reduced in a ramp-shaped manner to M_{HL} and M_{HR} (see FIG. 5), if the absolute quantity of the transverse acceleration a_{y} (322) is greater than an applicable value K_a_{y}, or the absolute value of the yaw rate v_{Gi} (317) is greater than an applicable value K_v_{Gi} or the absolute quantity of the steering angle L_{W} (312) is greater than an applicable value K_L_{W}: |a_{y}|>K_a_{y}, |v_{Gi}|>K_v_{Gi}, and |L_{ω}|>K_L_{ω}.

The ramp increase is determined by the applicable parameter K_r_{ab}, according to the equation:

$$\frac{ⅆ M}{ⅆ t} = {K\_R}_{ab} .$$

If, after braking on a curve, straight-ahead braking is performed again, the transverse dynamics conditions named drop out, and torques M_{HL}**** and M_{HR}**** rise in ramp-shaped fashion with the increase K_Rᵤₚ starting from M_{HL} and M_{HR} up to M_{HL}*** and M_{HR}***.

When it comes to the modification of the braking force proportions of the rear axle, only measures should be carried out in which the braking torques are increased, but not reduced. For this reason, the resulting desired braking torques M′_{HL} and M′_{HR} are limited downwards by M_{HL} and M_{HR} according to

M′_{HL}=max(M_{HL}****, M_{HL}),

M′_{HR}=max(M_{HR}****, M_{HR}).

The limitation of the possible setpoint braking torques at the rear axle is made clearer with the aid of FIG. 5. While during a straight-away drive the modified setpoint braking torques M_{HL}*** and M_{HR}*** are used, in a drive on a curve one reverts to the original setpoint braking torques M_{HL} and M_{HR} ascertained by the BKV. In this context, the modified setpoint braking torques represent the upper boundary values, and the original setpoint braking torques represent the lower boundary values of the torque setting at the wheel brakes. In response to the continuous adjustment of the original, i.e. not modified, to the modified setpoint braking torques, or vice versa, the adjusted setpoint braking torques M_{HL}**** and M_{HR}**** are selected between these two boundary values M_{HL}*** and M_{HR}*** and M_{HL} and M_{HR} in such a way that a steady transition between the torque settings at the wheel brakes may be observed. Because of this steady transition one may prevent a sudden discontinuity in the control, and thereby prevent an impairment in the vehicle handling and the driving stability.

In order that the vehicle slowdown as a result of the braking force displacement to the rear vehicle axle shall not change, the sum of the wheel braking torques has to remain unchanged. Consequently, for front axle braking torque M_{VA}′ one obtains:

M_{VA}′=M_{HL}+M_{HR}+M_{VL}+M_{VR}−M_{HL}′−M_{HR}′

On the assumption that the force-locking stress of the two front wheels is supposed to be equal, the follow two equations apply:

M_{VA}′=M_{VL}′+M_{VR}′

and

M_{VL}′/F_{N,VL}=M_{VR}′/F_{N,VR}

for the two braking torques M′_{VL} and M′_{VR}, where F_{N,VL} and F_{N,VR} represent the dynamic wheel loads of the left and the right front wheels. From these two equations there follows, for the braking torques M′_{VL} and M′_{VR}:

$$\begin{matrix}{M}_{VL}^{′} = {M}_{V A}^{′} \cdot \frac{{F}_{N , VL}}{{F}_{N , VL} + {F}_{N , VR}} \\ and \\ {M}_{VR}^{′} = {M}_{V A}^{′} \cdot \frac{{F}_{N , VR}}{{F}_{N , VL} + {F}_{N , VR}} .\end{matrix}$$

Alternatively, one may select the formulation that the current braking torque distribution between the left and the right front wheel should remain as it is, i.e.

$$\begin{matrix}\frac{{M}_{VL}}{{M}_{VL} + {M}_{VR}} = \frac{{M}_{VL}^{′}}{{M}_{V A}^{′}} \\ and \\ \frac{{M}_{VR}}{{M}_{VL} + {M}_{VR}} = \frac{{M}_{VR}^{′}}{{M}_{V A}^{′}}\end{matrix}$$

From this, there follows for both front wheel braking torques

$${M}_{VL}^{′} = {M}_{V A}^{′} \cdot \frac{{M}_{VL}}{{M}_{VL} + {M}_{VR}}$$

and

$${M}_{VR}^{′} = {M}_{V A}^{′} \cdot \frac{{M}_{VL}}{{M}_{VL} + {M}_{VR}}$$

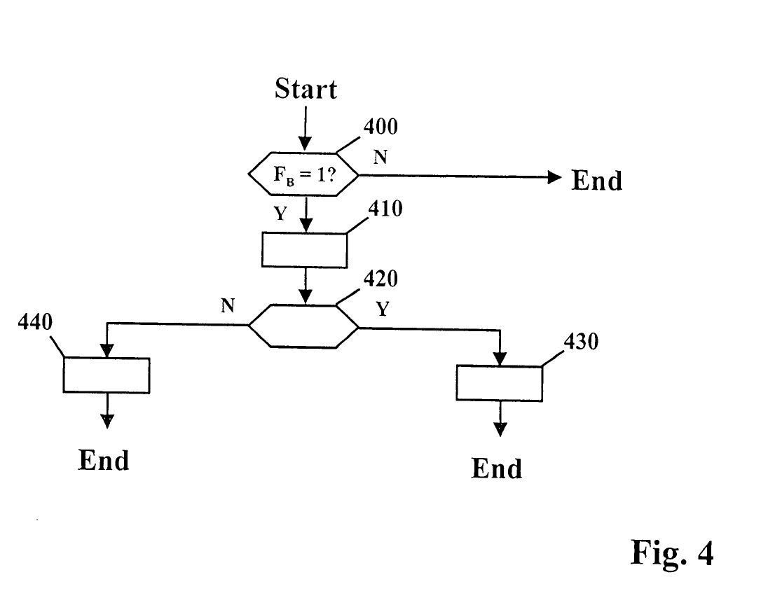

In FIG. 4, the modification of the braking torques for reasons of energy recovery is shown. After the start of the algorithm, it is checked in step 400 whether the driving situation and/or the vehicle components required for the energy recovery are available. If that is not the case, the algorithm is ended. If both conditions are satisfied, in step 410 a modification of the braking torques, as described above, is carried out and passed on to brakes control 360. In step 420, the loading state of the battery is checked. In this context, the maximum loading of the battery is checked. If the possibility exists of feeding the energy regained by the energy recovery into the battery, this is carried out in step 430. However, if the battery is already at a maximum loading point, or if the battery has reached its maximum loading state, users in the vehicle are activated in step 440 which remove the recovered energy. Such a user may be, for example, the vehicle lighting and/or heating system in the vehicle.

In one further exemplary embodiment, it may be checked already in step 400 whether the battery is able to be loaded by the energy recovery, or not. In this context, for example, the energy recovery is operated only if the battery still possesses loading capacity. In addition, it may be checked whether, besides the battery, other users in the vehicle may be switched in, in order to conduct away the energy obtained.

List of Reference Numerals

F_{B} flag that indicates a braking procedure

T_{B,i} temperature at the friction partners of a wheel brake i

μᵢ friction value between the friction partners of wheel brake i

SW_{T,i} temperature threshold value at wheel brake i

SW_{μ,i} friction threshold value at wheel brake i

SW_{V,i} wear threshold value at wheel brake i

112 braking command F_{B}

115 temperature sensors and or friction value sensors at the friction partners of the wheel brakes

117 temperature T_{B,i} at the friction partners and/or friction value μᵢ at wheel brake i

120 wear model and/or wear sensors at the wheel brakes

122 wear values Vᵢ for the individual wheel brakes

125 braking system

127 operating state of the braking system (braking power, instantaneous slowdown at the individual wheel brakes)

130 engine control

135,310 steering

137,312 steering angle L_{W}

140 battery

142 loading state of the battery

145 energy-absorbing components in the vehicle

145 operating state of the energy-absorbing components

160 acoustical and/or optical indication

175 energy-absorbing components in the vehicle

180 engine control

185 braking system control (among other things, braking force distribution control)

190 storage of the threshold values

199 garage/service technician

315 system for ascertaining the vehicle's yaw rate

317 yaw rate v_{Gi}

320 tire sensors for ascertaining the transverse acceleration of a tire

322 tire transverse acceleration a_{y}

325 system for ascertaining the vehicle's speed

327 vehicle speed v_{vehicle}

332 usable wheel brake power Pₘₐₓ

340 braking force distribution (BKV)

342-348 setpoint braking torques of the BKV

362-368 modified setpoint braking torques

What is claimed is:

1. A method for monitoring and controlling a braking system of a vehicle, in which for the monitoring, at least one braking variable is recorded that represents a retarding force of at least one wheel brake to represent at least a slowdown of at least one wheel, the method comprising:
performing at least one suitable measure of (i)modifying the slowdown at the at least one wheel brake, and (ii) leaving an overall slowdown of the vehicle constant or essentially constant so that there is only insignificant change;
wherein the at least one suitable measure is performed as a function of at least one of a comparison of a recorded braking variable to at least one predefined threshold value, a driving situation, and an operating state of a vehicle component located in the vehicle during a braking procedure.

2. The method of claim 1, wherein the suitable measure includes at least one of: (a) a redistribution of the retarding force of at least one wheel brake to other vehicle brakes of the vehicle, (b) an unloading of the wheel brakes by a utilization of energy-absorbing components of the vehicle, and (c) a modification of the engine control.

3. The method of claim 1, wherein the braking variable represents a loading of the wheel brake during a braking activity, it being especially provided that, and the braking variable includes at least one of (a) a temperature variable representing a temperature at at least one friction partner of the wheel brake, (b) a friction value variable representing a friction value between friction partners of the wheel brake, (c) a wear variable representing a wear of a brake lining of the wheel brake, (d) a braking power of the wheel brake, (e) a current slowdown of the wheel brake to be recorded, and (f) a change over time of the loading of the wheel brake to be recorded.

4. The method of claim 1, wherein for the driving situation, performing at at least one of (i) recording a behavior over time of at least one of a braking command and a steering command, by at least one of the driver and a component in the vehicle for braking control or steering control, and (ii) performing plausibility interrogations with respect to the control and loading of components present in the vehicle.

5. The method of claim 1, wherein:
the vehicle component includes at least one of a battery, at least one wheel brake, and an engine, and
an operating state of the vehicle component includes at least one of a loading state of the battery, a functioning state of the wheel brakes, an instantaneous braking power at the wheel brakes, and an instantaneous engine power.

6. The method of claim 2, wherein for the redistribution of the retarding force to energy-absorbing components, a displacement of the braking force distribution from the wheel brakes of a non-driven axle to the wheel brakes of a driven axle is performed.

7. A device for monitoring and controlling a braking system of a vehicle, in which for the monitoring, at least one braking variable is recorded that represents a retarding force of at least one wheel brake to represent at least a slowdown of at least one wheel, comprising:
an arrangement to perform at least one suitable measure of (i) modifying the slowdown at the at least one wheel brake, and (ii) leaving an overall slowdown of the vehicle constant or essentially constant so that there is only insignificant change;
wherein the at least one suitable measure is performed as a function of at least one of a comparison of a recorded braking variable to at least one predefined threshold value, a driving situation, and an operating state of a vehicle component located in the vehicle during a braking procedure.

8. The device of claim 7, wherein the suitable measure includes at least one of: (a) a redistribution of the retarding force of at least one wheel brake to other vehicle brakes of the vehicle, (b) an unloading of the wheel brakes by a utilization of energy-absorbing components of the vehicle, and (c) a modification of the engine control.

9. The device of claim 7, wherein the braking variable represents a loading of the wheel brake during a braking activity, it being especially provided that, and the braking variable includes at least one of (a) a temperature variable representing a temperature at at least one friction partner of the wheel brake, (b) a friction value variable representing a friction value between friction partners of the wheel brake, (c) a wear variable representing a wear of a brake lining of the wheel brake, (d) a braking power of the wheel brake, (e) a current slowdown of the wheel brake to be recorded, and (f) a change over time of the loading of the wheel brake to be recorded.

10. The device of claim 7, wherein for the driving situation, performing at at least one of (i) recording a behavior over time of at least one of a braking command and a steering command, by at least one of the driver and a component in the vehicle for braking control or steering control, and (ii) performing plausibility interrogations with respect to the control and loading of components present in the vehicle.

11. The device of claim 7, wherein:
the vehicle component includes at least one of a battery, at least one wheel brake, and an engine, and
an operating state of the vehicle component includes at least one of a loading state of the battery, a functioning state of the wheel brakes, an instantaneous braking power at the wheel brakes, and an instantaneous engine power.

12. The method of claim 8, wherein for the redistribution of the retarding force to energy-absorbing components, a displacement of the braking force distribution from the wheel brakes of a non-driven axle to the wheel brakes of a driven axle is performed.
